(19) United States
(12) Patent Application Publication
(10) Pub. No.: US 2008/0162142 A1
(43) Pub. Date: Jul. 3, 2008

(54) EMOTION ABREACTION DEVICE AND USING METHOD OF EMOTION ABREACTION DEVICE

(75) Inventors: Hung-Hsiu Yu, Changhua County (TW); Yi-Yi Yu, Kaohsiung City (TW); Ching-Yi Liu, Taichung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: INDUSTRIAL TECHNOLOGY RESEARCH INSTITUTE, Hsinchu (TW)

(21) Appl. No.: 11/696,189

(22) Filed: Apr. 4, 2007

(30) Foreign Application Priority Data
Dec. 29, 2006 (TW) 95149995

(51) Int. Cl. G10L 21/00

(52) U.S. Cl. 704/272

(57) ABSTRACT

An emotion abreaction device including a body, a control unit, a man machine interacting module and an emotion abreaction unit is provided. The control unit, the man machine interacting module and the emotion abreaction unit are disposed in the body. The man machine interacting module is electrically connected to the control unit for the user to select an emotion abreaction mode. The emotion abreaction unit is electrically connected to the control unit and has at least one sensor to measure force and/or volume for the user to abreact by knocking and/or yelling. Moreover, a using method of an emotion abreaction device includes turning on the emotion abreaction device, and then, responding to the user with a voice and/or an image according to the sensing result of the magnitude of the volume and/or the force after the user knocks and/or yells to an emotion abreaction unit of the emotion abreaction device.

### CROSS-REFERENCE TO RELATED APPLICATION

This application claims the priority benefit of Taiwan application serial no. 95149995, filed Dec. 29, 2006. All disclosure of the Taiwan application is incorporated herein by reference.

### BACKGROUND OF THE INVENTION

1. Field of the Invention

The present invention relates to an emotion abreaction device and the using method of the emotion abreaction device. More particularly, the present invention relates to an emotion abreaction device for a user to abreact his or her emotions by knocking and/or yelling and the using method of the emotion abreaction device.

2. Description of Related Art

It's difficult to be a modern office staff, as the competition in the companies is very stressful, and it has a high requirement for the life quality. A survey shows that, nearly 8 out of 10 office staffs feel deeply depressed, and 2 of them even have the idea of committing suicide. Since modern people lack of the appropriate and correct means for abreaction, social phenomena such as melancholia, family violence, and alcohol abuse occurred accordingly also demand great attentions. Therefore, how to establish an appropriate and correct means for emotion abreaction has become a researching subject deserving great efforts.

Japanese Patent Publication No. 2005-185630 discloses an emotion mitigation system, which analyzes the noises received from a baby or an animal to determine whether it is in an emotionally nervous state. If the baby or animal is determined to be in an emotionally nervous state, the system will mitigate its nervous emotion through sounds, remotely-controlled toys, and remotely-controlled lamp lights. Japanese Patent Publication No. 2006-123136 discloses a communication robot, which analyzes the emotion state of the caller by retrieving his/her facial image and voice. If the caller is determined to be in an emotionally nervous state, the robot mitigates the caller's nervous emotion by way of singing a song and the like.

However, the above two patents both mitigate the caller's nervous emotions through a mild way of music and toys, after the emotions of the user or caller have been determined. With regard to a user with tense emotions, the emotion mitigation effect through the above processes is not desirable, which also lacks of the interaction with the user.

### SUMMARY OF THE INVENTION

Accordingly, the present invention is directed to an emotion abreaction device with preferred emotion mitigation and abreaction effects.

The present invention is also directed to a using method of an emotion abreaction device with preferred emotion mitigation and abreaction effects.

The present invention provides an emotion abreaction device, which comprises a body, a control unit, a man machine interacting module and an emotion abreaction unit, wherein the control unit, the man machine interacting module, and the emotion abreaction unit are disposed in the body. The man machine interacting module is electrically connected to the control unit for the user to input commands to the control unit, which commands comprise selecting an emotion abreaction mode. The emotion abreaction unit is electrically connected to the control unit and has at least one sensor to measure force and/or volume, for the user to abreact his or her emotions by way of knocking and/or yelling. The emotion abreaction unit delivers a sensing result to the control unit, and the control unit controls the man machine interacting module to respond to the user with at least one of a voice and an image based on the sensing result.

The present invention provides a using method of an emotion abreaction device, which comprises: turning on the emotion abreaction device; next, when a user knocks the emotion abreaction unit of the emotion abreaction device, measuring a magnitude of the user's knocking force; then, responding to the user with at least one of a voice and an image based on the measured magnitude of the force; then, when the user yells to the emotion abreaction unit of the emotion abreaction device, measuring the magnitude of the volume of the user's yelling; and then, responding to the user with at least one of a voice and an image based on the measured magnitude of the volume.

To sum up, in the emotion abreaction device and the using method of the emotion abreaction device of the present invention, the user is capable of abreacting his or her emotions and gets response, which enables the user to get complete emotion abreaction in the aspects of both physiology and psychology.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A and 1B are respectively a front view and a side view of an emotion abreaction device according to an embodiment of the present invention.

FIGS. 2A and 2B are respectively a front view and a side view of an emotion abreaction device according to another embodiment of the present invention.

FIG. 3 is the flow chart of a using method of an emotion abreaction device according to an embodiment of the present invention.

### DESCRIPTION OF EMBODIMENTS

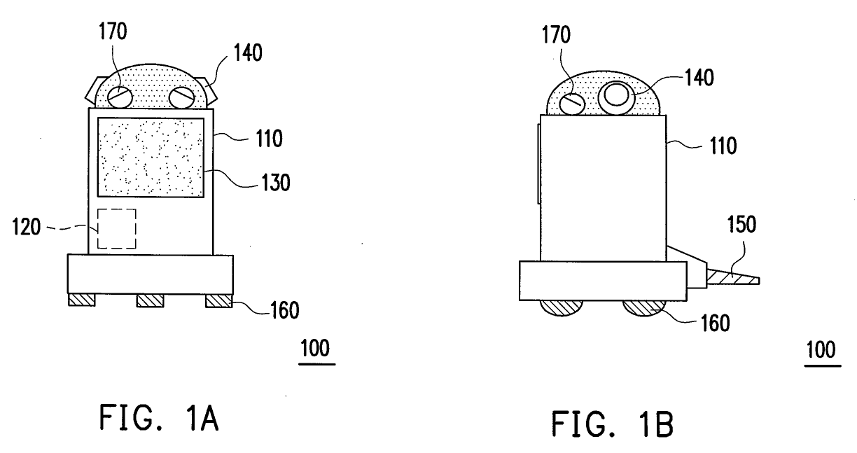

FIGS. 1A and 1B are respectively a front view and a side view of an emotion abreaction device according to an embodiment of the present invention. Referring to FIGS. 1A and 1B, the emotion abreaction device 100 of this embodiment includes a body 110, a control unit 120, a man machine interacting module 130, and two emotion abreaction units (including a yelling abreaction unit 140 and a knocking abreaction unit 150). The body 110 is mainly provided for the control unit 120, the man machine interacting module 130, the yelling abreaction unit 140, and the knocking abreaction unit 150 to be disposed thereon. Of course, the body 110 may assume an appearance design with personification or objectification features, in order to further improve the scenario abreaction effects. The man machine interacting module 130, the yelling abreaction unit 140, and the knocking abreaction unit 150 are all electrically connected to the control unit 120. The man machine interacting module 130 is used for the user to input commands to the control unit 120, which commands comprise selecting an emotion abreaction mode. The commands inputted to the man machine interacting module 130 may used for choosing modes or confirming/canceling the operation to be performed. The emotion abreaction unit, which includes the yelling abreaction unit 140 and the knocking abreaction unit 150, delivers a sensing result to the control unit 120. The control unit 120 then controls the man machine interacting module 130 to respond to the user with at least one of a voice and an image based on the sensing result.

Although the emotion abreaction device 100 of this embodiment includes two emotion abreaction units of the yelling abreaction unit 140 and the knocking abreaction unit 150, it may optionally be configured with only the yelling abreaction unit 140 or the knocking abreaction unit 150. The yelling abreaction unit 140 has a volume sensor (not shown), which enables the user to abreact the emotions by way of yelling, and the volume sensor is also commonly referred as decibel meter. The knocking abreaction unit 150 has a force sensor (not shown), which enables the user to abreact the emotions by way of knocking, and the force sensor may be an accelerometer.

Since the emotion abreaction device 100 has the yelling abreaction unit 140 and the knocking abreaction unit 150, it enables the user to abreact the emotions through a relatively furious process, such as yelling or knocking etc, thereby achieving preferred effects in emotion mitigation and abreaction. Furthermore, the emotion abreaction device 100 can also measure the magnitude of the volume of the yelling and that of the knocking force of the user, and thereby responding to the user according to the measured results, and thus providing the user with a bi-directional interaction scenario and feeling during his or her emotion abreaction. Thus, the emotion mitigation and abreaction effect is further improved.

Other alternative variations in the emotion abreaction device 100 of this embodiment are described below with reference to FIGS. 1A and 1B. The emotion abreaction device 100 may further include a moving unit 160 disposed in the body 110 and electrically connected to the control unit 120, which can move the body 110 based on the instruction of the control unit 120. The man machine interacting module 130 may include a touch screen, which provides image displaying and command inputting functions, and the image for being displayed may be built in or externally input. In addition, the emotion abreaction device 100 may further include an image input unit 170 disposed in the body 110 and electrically connected to the control unit 120, such that the man machine interacting module 130 can display the image input from the image input unit 170. Alternatively, the man machine interacting module 130 may include a screen and a command input device (not shown), and similarly, the screen of the man machine interacting module 130 can display the image input from the image input unit 170. The command input device of the man machine interacting module 130 may be a keyboard, a mouse, a touch pad, or another suitable command input device. Of course, the man machine interacting module 130 may also include a speaker (not shown) to provide voice interaction.

Furthermore, the image input unit 170 may also be used as an object detector, for detecting the approaching or departing of the user, and thereby automatically turning on or turning off the emotion abreaction device 100. Of course, the object detector may be an infrared detector or other suitable detectors. Although the image input unit 170 may be an image capturing device such as charge coupled device (CCD), it may alternatively be a card reader, an optical disk drive, a universal serial bus (USB), a blue-tooth transmission module, or any component that enables the user to input images into the emotion abreaction device 100 from an external device. Moreover, the emotion abreaction device 100 may be driven by various energies such as an internal battery, an externally-connected power source, or a solar cell.

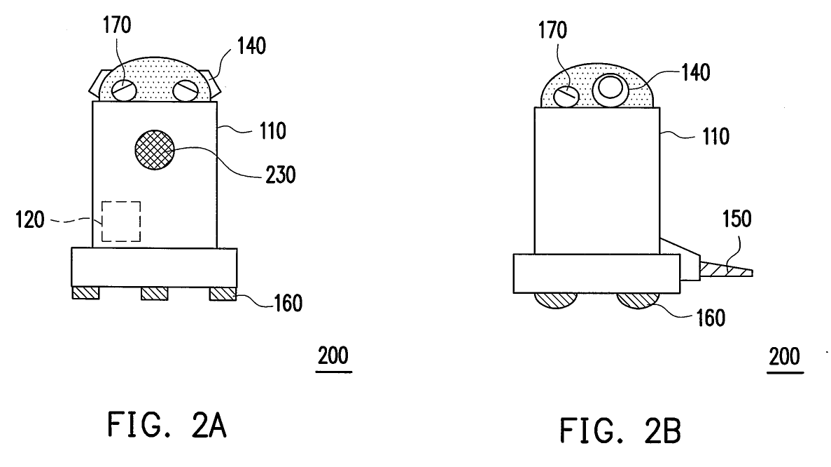

FIGS. 2A and 2B are respectively a front view and a side view of an emotion abreaction device according to another embodiment of the present invention. Referring to FIGS. 2A and 2B, the emotion abreaction device 200 of this embodiment is similar to the emotion abreaction device 100 of FIG. 1A, and only the differences there-between are described herein. The man machine interacting module 230 of the emotion abreaction device 200 includes a voice control interface. That is, the man machine interacting module 230 enables the user to interact with the control unit 120 via voices. Specifically, the control unit 120 can control the man machine interacting module 230 to greet the user or provide user with function options through voices, and determines and executes the voice command received by the man machine interacting module 230, and further controls the man machine interacting module 230 to respond to the user through voices. Furthermore, the emotion abreaction device 200 is additionally disposed with a screen (not shown) merely for displaying, which is disposed in the body 110 and electrically connected to the control unit 120. The screen not only can be used to interact with the user by way of images, but display the image input from the image input unit 170.

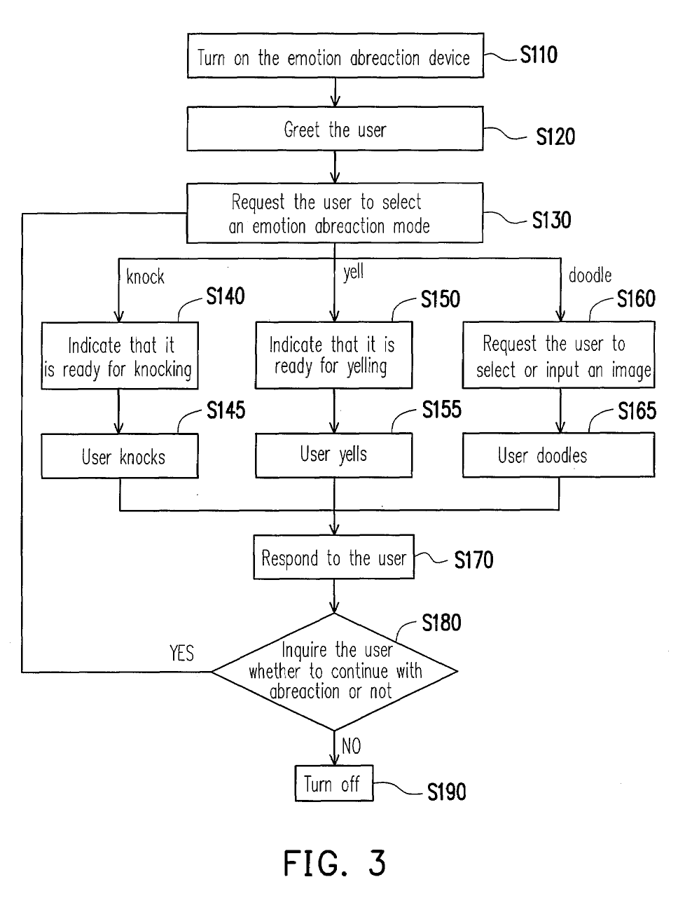

FIG. 3 is a flow chart of a using method of an emotion abreaction device according to an embodiment of the present invention. The using method of an emotion abreaction device of this embodiment is applicable for the emotion abreaction device 100 of FIG. 1A, the emotion abreaction device 200 of FIG. 2A, or other emotion abreaction devices capable of performing this method.

Referring to FIGS. 1A, 1B, and 3, the using method of the emotion abreaction device includes the following steps: firstly, the emotion abreaction device 100 is turned on, in step S110. The process for turning on the emotion abreaction device 100 includes manually turning on by a user, or automatically turning on by an object detector (for example, the image input unit 170) upon detecting the approaching of a user.

Next, in step S120, the user is selectively greeted with voice and/or image immediately after the emotion abreaction device has been turned on. For example, a greeting voice of “Good day, master, would you like to abreact your emotions?” is given out, or a greeting image is displayed, or both of the above voices and images are used.

Then, the user is selectively requested to choose at least one emotion abreaction mode from knocking and yelling, in step S130. For example, a voice of “Please select” is given out, or a menu image is displayed, or both of the above voices and images are used. If the emotion abreaction device 100 has a touch screen (for example, the man machine interacting module 130), it can further provide an option of doodling to the user. The process for providing the options to the user includes providing voice options or displayed on the screen, depending on whether the emotion abreaction device 100 has a unit for giving out voices or displaying pictures or not. Similarly, the user can select by means of providing voice commands, pressing keys, or pressing a touch screen, depending on the type of the command input interface provided by the man machine interacting module 130 of the emotion abreaction device 100. Of course, the emotion abreaction device 100 and the user may use other suitable means to provide options and select the options respectively.

If the user has selected to abreact the emotions by means of knocking, the user may be selectively indicated when to knock, in step S140. For example, the voice “5, 4, 3, 2, 1, please beat me!” is played, or a counting-down image is displayed, or both of the above voices and images are used. Then, when the user knocks the knocking abreaction unit 150 of the emotion abreaction unit 100, in step S145, the magnitude of the user's knocking force is measured.

If the user has selected to abreact the emotions by means of yelling, the user may be selectively indicated when to yell, in step S150. For example, the voice “5, 4, 3, 2, 1, please shout at me!” is played, or a counting-down image is displayed, or both of the above voices and images are used. Then, as the user yells at the yelling abreaction unit 140 of the emotion abreaction unit 100, in step S155, the magnitude of the volume of the user's yelling at the abreaction unit 140 is measured.

Furthermore, regardless of whether the user is knocking or yelling, the voices of “Sorry, I was wrong”, “Master, please forgive me”, or another voice that is helpful for the user to abreact the emotions is played synchronously, or otherwise, the picture of a twisted face or another picture that is helpful for the user to abreact the emotions is displayed in images, or both of the above voices and images are used.

If the user has selected to abreact the emotions by doodling, the user is selectively requested to select a built-in image or an externally-input image, such as a photo of an annoying guy, and the image is displayed on the touch screen (for example, the man machine interacting module 130), in step S160. If the user does not input or select an image, the control unit 120 can automatically determine the image to be displayed or determine to be blank on the screen. Then, the user doodles on the touch screen by hands or through an appropriate tool, e.g., a stylus, in step S165.

Then, based on the resulted doodling work, the magnitude of the force and/or the volume, the user is responded through a voice and/or an image, in step S170. The process for responding to the user includes appearing to be suffered or miserable, informing the user about the magnitude of the force or the volume, imitating running away by moving the emotion abreaction device 100 and/or encouraging the user. For example, the voice of “Master, you are terrific”, “Master, have you always being so strong”, “Master, your anger index is XX points”, or another voice that is helpful for the user to abreact emotions, otherwise, an image capable of achieving the same effect is displayed, or moving the body 110 by the moving unit 160 to imitate running away while the user is knocking, yelling, and/or doodling, or using a combination of the above processes.

Then, the user is selectively inquired whether to continue to abreact the emotions or not, in step S180. If the user wants to continue to abreact the emotions, it returns to S130, or jumps directly to the step S145, S155, or S165. If the user does not want to continue to abreact the emotions, the device is turned off, in step S190. Of course, if the user doesn't respond about whether to continue to abreact the emotions or not, the emotion abreaction device 100 may also be set to be automatically turned off after a certain waiting time.

It should be noted that, in the using method of this embodiment, after turning on of the emotion abreaction device 100, i.e., the step S110, the steps S120 to S160 may be skipped to enable the user to directly knock, yell, or doodle (steps S145, S155, S165), thereby providing the user with the most instant and rapid emotion abreaction. The flow chart is not additionally depicted herein.

In view of the above, the emotion abreaction device of the present invention enables the user to abreact the emotions through a furious means of knocking and/or yelling, and has at least one sensor for sensing the magnitude of the force and/or the volume to respond to the user accordingly. Furthermore, in the using method of the emotion abreaction device of the present invention, the magnitude of the knocking force and/or that of the volume of the yelling of the user is measured, and based on the sensed magnitude of the volume and/or force, an emotion index is presented through voice and/or image, thereby responding to the user, and thus, enabling the user to deeply feel the bi-directional interaction scenario. Therefore, both can provide an appropriate and harmless process for abreaction, reduce social problems, and improve life quality, and enable users to achieve a complete abreaction in the aspects of both physiology and psychology.

It will be apparent to those skilled in the art that various modifications and variations can be made to the structure of the present invention without departing from the scope or spirit of the present invention. In view of the foregoing, it is intended that the present invention cover modifications and variations of this invention provided they fall within the scope of the following claims and their equivalents.

What is claimed is:

1. An emotion abreaction device, comprising:
a body;
a control unit, disposed in the body;
a man machine interacting module, disposed in the body and electrically connected to the control unit, for the user to select an emotion abreaction mode to the control unit; and
an emotion abreaction unit, disposed in the body and electrically connected to the control unit, having at least one sensor to measure force and/or volume, for the user to abreact through at least one way of knocking and yelling, wherein the emotion abreaction unit transfers a sensing result to the control unit, and the control unit controls the man machine interacting module to respond to the user with at least one of a voice and an image based on the sensing result.

2. The emotion abreaction device as claimed in claim 1, further comprising a moving unit, disposed in the body and electrically connected to the control unit, wherein the control unit controls the moving unit to move the body based on the sensing result.

3. The emotion abreaction device as claimed in claim 1, wherein the man machine interacting module comprises a voice control interface, for the user to interact with the control unit through voices.

4. The emotion abreaction device as claimed in claim 1, wherein the man machine interacting module comprises a screen and a command input device.

5. The emotion abreaction device as claimed in claim 4, further comprising an image input unit, disposed in the body and electrically connected to the control unit, wherein the screen is used to display an image input from the image input unit.

6. The emotion abreaction device as claimed in claim 1, wherein the man machine interacting module comprises a touch screen.

7. The emotion abreaction device as claimed in claim 6, further comprising an image input unit, disposed in the body and electrically connected to the control unit, wherein the touch screen is used to display an image input from the image input unit.

8. The emotion abreaction device as claimed in claim 1, further comprising an image input unit and a screen, disposed in the body and electrically connected to the control unit, wherein the screen is used to display an image input from the image input unit.

9. The emotion abreaction device as claimed in claim 1, further comprising an object detector, disposed in the body and electrically connected to the control unit, for automatically turning on or off the emotion abreaction device upon detecting the user's approaching or departing.

10. A using method of an emotion abreaction device, comprising:
turning on the emotion abreaction device;
when a user is knocking an emotion abreaction unit of the emotion abreaction device, measuring a magnitude of the user's knocking force;
responding to the user with at least one of a voice and an image based on the measured magnitude of the force;
when the user is yelling at the emotion abreaction unit of the emotion abreaction device, measuring the magnitude of the volume of the user's yell; and
responding to the user with at least one of a voice and an image based on the measured magnitude of the volume.

11. The using method of the emotion abreaction device as claimed in claim 10, further comprising requesting the user to select at least one emotion abreaction mode from knocking and yelling, after the emotion abreaction device is turned on and before the magnitude of the knocking force or the volume of the yelling of the user are measured.

12. The using method of the emotion abreaction device as claimed in claim 11, further comprising indicating the user about when to knock, once the user has selected knocking.

13. The using method of the emotion abreaction device as claimed in claim 11, further comprising indicating the user about when to yell, once the user has selected yelling.

14. The using method of the emotion abreaction device as claimed in claim 11, wherein the process for the user to select an emotion abreaction mode comprises providing voice commands, pressing a key of the emotion abreaction device, or using a touch screen of the emotion abreaction device.

15. The using method of the emotion abreaction device as claimed in claim 10, wherein the process for turning on the emotion abreaction device comprises manually turning on the emotion abreaction device by the user or automatically turning on upon sensing the approaching of the user.

16. The using method of the emotion abreaction device as claimed in claim 10, further comprising greeting the user with at least one of a voice and an image immediately after the emotion abreaction device is turned on.

17. The using method of the emotion abreaction device as claimed in claim 10, further comprising providing a touch screen of the emotion abreaction device for the user to doodle thereon.

18. The using method of the emotion abreaction device as claimed in claim 17, further comprising requesting the user to select or input an image to be displayed on the touch screen after the emotion abreaction device is turned on and before the user starts to doodle.

19. The using method of the emotion abreaction device as claimed in claim 10, further comprising inquiring the user whether to continue abreacting or not and enabling the user to abreact once again or turning off based on the user's command after responding to the user.

20. The using method of the emotion abreaction device as claimed in claim 10, wherein the process for responding to the user comprises at least one of appearing to be suffered or miserable, informing the user about the magnitude of the force or volume, imitating running away by moving the emotion abreaction device, and encouraging the user.
